(19) United States
(12) Patent Application Publication
(10) Pub. No.: US 2020/0137858 A1
(43) Pub. Date: Apr. 30, 2020

(54) AN OCCUPANCY SENSOR FOR USE IN A LIGHTING SYSTEM AND METHOD

(71) Applicant: SIGNIFY HOLDING B.V., EINDHOVEN (NL)

(72) Inventors: Paul Theodorus Jacobus BOONEN, EINDHOVEN (NL); John Brean MILLS, EINDHOVEN (NL); Maurice Herman Johan DRAAIJER, EINDHOVEN (NL)

(21) Appl. No.: 16/607,380

(22) PCT Filed: Apr. 11, 2018
(86) PCT No.: PCT/EP2018/059274

§ 371 Date: Oct. 23, 2019

(30) Foreign Application Priority Data
Apr. 25, 2017 (EP) 17167859.2

(51) Int. Cl. H05B 47/115; H05B 45/10; G01S 13/04; G01S 7/292

(52) U.S. Cl. CPC H05B 47/115; G01S 7/292; G01S 13/04; H05B 45/10

(57) ABSTRACT

The invention provides an occupancy sensor, for use in a lighting system, including a transceiver, wherein the transceiver is adapted to transmit and receive signals. The occupancy sensor further includes a controller, which is adapted to process signals received by the transceiver. Based on the signals received at the transceiver, the controller is adapted to detect a presence in the area of interest. The controller is further adapted to detect a predetermined pattern within the signals received at the transceiver and interpret a system message based on said pattern.

### FIELD OF THE INVENTION

This invention relates to the field of occupancy sensors, and more specifically to occupancy sensors with integrated communication means.

### BACKGROUND OF THE INVENTION

Recent advances in LED technology have led to the widespread use of LEDs in many lighting applications. One particular advantage of LED lighting is an increased level of control, such as dimming, compared to many traditional light sources. This has resulted in an increasing amount of LED lighting products being equipped with sensors. These sensors can be integrated into the LED lighting product or be provided separately to the LED lighting product, communicating by way of wired or wireless communication means.

One of the most common sensor functions used for lighting systems is occupancy, also referred to as presence or motion, detection. Occupancy detection exists in many forms, ranging from simple presence indication to counting the number of people occupying a room, and a variety of different types of sensors can be employed to achieve this.

There is often a need for lighting products to be configurable in the field after installation is complete. State of the art examples of in-field configuration communication means include Bluetooth, IR, ZigBee and Wi-Fi.

US2015/0184842 shows an example of lighting apparatus including an occupancy sensor and a communication interface.

By way of example, a series of LED lighting fixtures are installed in the streetlights of a residential area. The fixtures are equipped with microwave occupancy sensors. When there is no occupancy detected for a certain period of time, the lights will dim down to 20% output. This may be done because the local municipality wants to reduce energy consumption and limit luminous pollution during the night; however, the lighting covering road intersections in the residential area should not be reduced this far for traffic safety reasons. Thus, the manufacturer of the lighting fixtures includes a Bluetooth module in each individual streetlight to be used for communication and the setting of the default dimming level.

The disadvantage of this solution is that every lighting fixture has to be equipped with a Bluetooth module. This adds to the cost and standby energy consumption of the product, for a function that may only be used once or twice in its lifetime.

There is therefore a need for providing a means of communication within the lighting system, without increasing the manufacturing or running costs and/or power consumption of the lighting system.

### SUMMARY OF THE INVENTION

The invention is defined by the claims.

According to examples in accordance with an aspect of the invention, there is provided an occupancy sensor, for use in a lighting system, wherein the occupancy sensor comprises:

a transceiver, wherein the transceiver is adapted to transmit signals and to receive reflected signals corresponding to the transmitted signals;

a controller which is adapted to process reflected signals received by the transceiver, and to detect a presence in an area of interest based on the reflected signals received by the transceiver. The controller is further adapted to detect a predetermined pattern in the reflected signals received by the transceiver; and to interpret a system message based on the predetermined pattern detected in the reflected signals.

This occupancy sensor establishes a means of communication by way of the transceiver used for presence detection. The transceiver is adapted to transmit and receive signals. By transmitting signals and monitoring and processing the received reflected transmitted signals, it is possible for the occupancy sensor to monitor the occupancy of a region of interest. The controller of the occupancy sensor may determine that a monitored region is occupied based on the signals received at the transceiver. In this way, it is possible for the occupancy sensor to detect an occupant in a monitored region of interest.

If the transceiver receives a predetermined pattern, the controller may interpret said predetermined pattern as a system message. For example, if the predetermined pattern, and associated message, is generated by a user as a system control input, the controller may execute a predetermined system control instruction. In this way, it is possible for a user to communicate with the occupancy sensor by way of the transceiver.

In an embodiment, the transceiver is adapted to transmit and receive signals in the microwave frequency range.

In this way, it is possible for the signals transmitted by the transceiver to penetrate a large variety of materials, meaning that no optical window is required for the occupancy sensor to function in a system. In addition, the long range of the microwave emissions enables the occupancy sensor to monitor a large area.

By monitoring reflected transmit signals from the transceiver; it is possible for the occupancy sensor to omit background signals outside of the desired frequency range, which may otherwise erroneously indicate an occupant in the region of interest. For example, if a person moves into the field of view of the transceiver, the reflected signals received at the transceiver will change. This change in the monitored signal pattern may result in the controller detecting that the monitored region is occupied.

In some embodiments, the predetermined pattern comprises modulated reflected signal.

By including a modulated signal in the predetermined pattern within the reflected transmit signal, it is possible to differentiate the signals received at the transceiver from a standard occupancy. In this way, the controller may only interpret the signals as a system message if the modulated reflected signals are present, thereby reducing the risk of system message, such as a system instruction, being accidentally interpreted from the natural background signals.

In a further embodiment, the modulated reflected signals comprises a coded sequence or an artificial Doppler shift.

In this way, the modulated reflected transmit signal may be further differentiated from a standard occupancy signal and/or microwave background signals. By introducing an artificial Doppler shift to the modulated reflected signals, it is possible to further differentiate the modulated reflected signals from background signals. In particular, the artificial Doppler shift may help to differentiate the modulated signals from high magnitude reflected signals from larger stationary RADAR targets, such as large parked vehicles.

In an arrangement, the system message comprises a lighting system control instruction.

In this way, it is possible for the user to provide the controller with an instruction for controlling the lighting system by way of the transceiver. This means that an additional communication means is not required within the lighting system in order to remotely control the system behaviour.

According to examples in accordance with an aspect of the invention, there is provided a lighting system, the lighting system comprising:

a light source;

an occupancy sensor as described above; and

a control device for providing the predetermined pattern.

In this way, a lighting system may comprise an occupancy sensor adapted to both perform standard occupancy detection and act as a means of communication between a user and the system. The control device may function as an instruction device, and it may be a handheld device operated by a user of the lighting system. The instruction device may be adapted to generate at least part, for example the modulated portion, of the signals received at the transceiver when within the region of interest of the occupancy sensor.

In an embodiment, the system message is adapted to alter the output of the light source.

By adapting the predetermined instruction, executed by the controller of the occupancy sensor, to alter the output of the light source, it is possible to control the light source by way of the predetermined pattern. For example, the system message may comprise an instruction to prevent the dimming of the output of the light source below a certain level. Alternatively, the system message may be adapted to alter: the colour; lighting pattern; or any other output of the light source.

In an arrangement, the instruction device comprises:

an antenna structure, wherein the antenna structure is adapted to produce the predetermined pattern upon reflecting the transmitted signals; and

a control unit in communication with the antenna structure.

In this way, the pattern of the reflected transmit signals of the transceiver may be defined by the antenna structure, which may form the modulated reflected transmit signals received at the transceiver. The control unit may be adapted to alter the impedance of the antenna structure, which in turn alters the modulated reflected transmit signal. In this way, it is possible to convey more complex information to the occupancy sensor, which may then interpreted by the controller of the occupancy sensor.

In addition, the modulated reflected transmit signal may comprise encoded information, encrypted by the control unit of the instruction device, which may then be decrypted and interpreted by the controller of the occupancy sensor. In this way, the lighting system may only receive instructions from an authorised device, thereby preventing tampering with the system.

In a further arrangement, the antenna structure comprises a reflect-array.

By arranging the antenna structure into a reflect-array, it is possible to effectively re-radiate the transmit signal directly back towards the occupancy sensor of the lighting system, thereby increasing the operable range of angles at which the instruction device may be used. In this way, the user is not required to stand directly underneath the transceiver of the occupancy sensor in order to send an instruction to the lighting system, which may be difficult to locate. In addition, for the case of street lighting, this may allow the user to send an instruction to the lighting system away from the road, thereby increasing the safety of the user when using the system.

In an embodiment, the antenna structure comprises a dipole wire and optionally wherein the length of the dipole wire is a quarter of the wavelength of a signal transmitted by the transceiver.

In this way, it is possible to construct the antenna as an array of quarter-wave monopole antennas or, by connecting two lengths of dipole wire end to end, half-wave dipole antennas. In both cases, the re-radiated signals, i.e. the modulated reflected transmit signals, are strongest in the directions normal to the length of the dipole wire, meaning that the re-radiated signals can be easily directed towards the occupancy sensor of the lighting system by the user.

In some designs, a Fresnel zone is established between the antenna structure and the transceiver, wherein the antenna structure is at least twice as large as the radius of the first Fresnel zone, for example three times as large.

In this way, a large enough proportion of the transmit signals is reflected by the antenna structure, thereby ensuring that the reflected signals are received and detected by the transceiver.

In an embodiment, the instruction device further comprises a switch in communication with the antenna structure and the controller, wherein the switch is adapted to change the impedance of the antenna structure.

By providing a switch in the antenna structure, such as a mechanical switch or a semiconductor circuit, it is possible for the user to manually alter the impedance of the antenna structure. For example, this may be used in an initial communication stage as a user verification before instructions may be received by the system. The user may be required to manually alter the impedance of the antenna structure in a predetermined pattern, which acts as a passcode, thereby allowing the user to begin sending instructions to the lighting system. In this way, an unauthorised user may be prevented from tampering with the lighting system even if in possession of the instruction device.

Alternatively, or in addition, the control unit of the instruction device may control the switch in order to change the impedance of the antenna structure, for example, to generate the modulated reflected transmit signal.

In an arrangement, the antenna structure further comprises at least one of: an absorptive switch; a reflective switch; a phase shifter; and a vector modulator element.

In this way, the modulated reflected transmit signals may be amplitude, phase or amplitude and phase modulated upon reflection by the antenna structure, respectively. This may be done to tune the modulated reflected transmit signals to further differentiate them from any background signals.

The invention also provides the instruction device itself. Thus, examples in accordance with a further aspect provide a lighting system control device for communicating with an occupancy sensor as defined above for providing the lighting system control instruction, for controlling a light source associated with the occupancy sensor, wherein the control device comprises:

an antenna structure, wherein the antenna structure is adapted to produce the modulated reflected signals; and

a control unit in communication with the antenna structure.

According to examples in accordance with another aspect of the invention, there is provided a method for operating an occupancy sensor, the method comprising:

Transmitting signals and receiving reflected signals corresponding to the transmitted signals by way of a transceiver;

processing the reflected signals by the transceiver (220) for detecting a presence in an area of interest based on the reflected signals received by the transceiver;

detecting a predetermined pattern (68) in the reflected signals received by the transceiver; and

interpreting a system message based on the predetermined pattern.

### BRIEF DESCRIPTION OF THE DRAWINGS

Examples of the invention will now be described in detail with reference to the accompanying drawings, in which:

FIG. 1 shows a schematic view of an occupancy sensor;

FIG. 2 show a schematic view of a lighting system comprising the occupancy sensor shown in FIG. 1;

FIG. 3 shows a schematic view of an instruction device;

FIG. 4 shows an example a lighting system comprising the occupancy sensor of FIG. 1 and the reflect-array antenna of FIG. 3; and

FIG. 5 shows a method of the invention.

### DETAILED DESCRIPTION OF THE EMBODIMENTS

The invention provides an occupancy sensor, for use in a lighting system, including a transceiver, wherein the transceiver is adapted to transmit and receive signals. The occupancy sensor further includes a controller, which is adapted to process signals received by the transceiver. Based on the signals received at the transceiver, the controller is adapted to detect a presence in the area of interest. The controller is further adapted to detect a predetermined pattern within the signals received at the transceiver and interpret a system message based on said pattern.

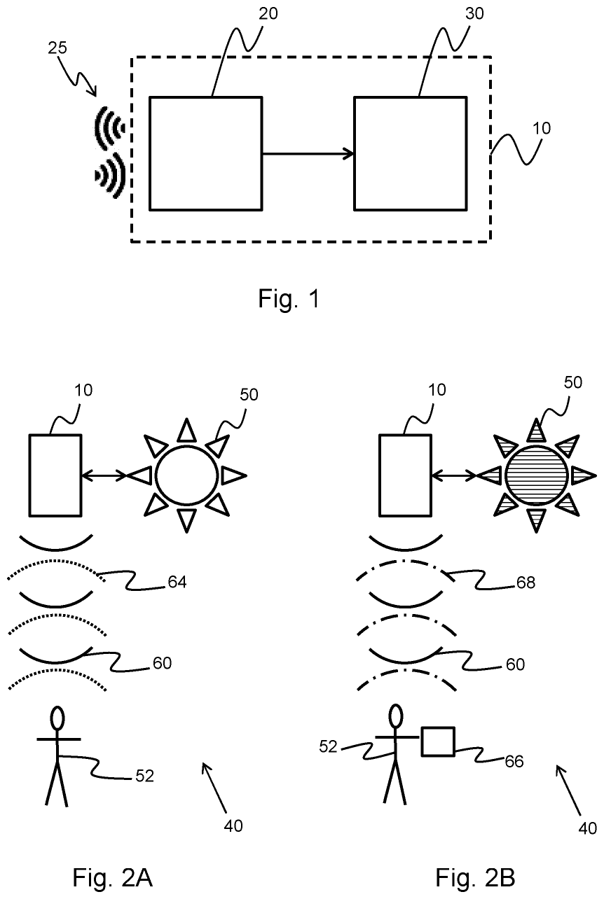

FIG. 1 shows an occupancy sensor 10 according to an embodiment. The occupancy sensor comprises a transceiver 20, wherein the transceiver is adapted to transmit and receive signals 25. The signals may, for example, be in the microwave frequency range between 300 MHz to 300 GHz, for example between 1 GHz and 300 GHz.

The transceiver emits transmit signals over a region of interest. The transmit signals are reflected by surfaces within the region of interest and reflected signals incident on the occupancy sensor are received by the transceiver. These received signals may then be provided to a controller 30 which is adapted to process signals received by the transceiver.

The processing of the received signals may comprise signal amplification and pattern recognition. Typically, the controller 30 will perform analogue to digital conversion on the signals received at the transceiver. In this way, the information from the transceiver can be classified in to categories of movement and occupancy. For example, signals received at the transceiver of a given Doppler shifted frequency with a given amplitude and repeatability may represent an object moving with certain speed in the region of interest. Signal patterns associated with motions of interest may be predetermined, categorized and programmed into the controller 30, so that it can easily recognise such signals.

The controller is further adapted to recognise signal patterns and changes in said signal patterns. For a certain received signal pattern at the transceiver, the controller may determine that the region of interest is occupied. For example, the region of interest may be a room, wherein the occupancy sensor is installed in the ceiling of the room. When the room is unoccupied, the signal patterns received by the occupancy sensor, which are known by the controller, do not change. If a person were to enter the room, the signal patterns received by the transceiver of the occupancy sensor would change. The controller may interpret these signal patterns as the given received signal pattern, thereby indicating to the controller that the room is now occupied. The signal patterns may comprise reflected transmit signals, for example transmit signals reflected by the body of an occupant.

For another received signal pattern, which is different from the previous example, the controller may determine that a function other than standard occupancy detection needs to be performed. Returning to the previous example, a user capable of generating a predetermined signal pattern may enter the room. In this case, the controller of the occupancy detector may interpret the predetermined pattern as a system message, such as a system control instruction. The controller may be adapted to interpret different predetermined patterns as different messages, which may be used to execute various different instructions depending on the exact nature of the received signal pattern. The various predetermine pattern interpretations may be stored in a lookup table according their associated received signal patterns.

As the generation of the predetermined pattern often requires a user to be present, the signals received at the transceiver may comprise a reflected transmit signal from the transceiver, similar to the reflected transmit signal in the standard occupancy case, and a modulated reflected transmit signal from the transceiver. The modulated reflected transmit signal acts to differentiate the signal pattern from a standard occupancy signal pattern, thereby indicating to the controller, adapted to recognise the modulated reflected transmit signal within the received signals, that an instruction should be executed. The modulated transmit signal is designed such that it would not occur under standard operating conditions, thereby reducing the risk of an unintentional instruction being executed by the controller. In order to achieve this, it may be required to receive the modulated reflected transmit signal multiple times before the instruction is executed by the controller.

In order to further differentiate the predetermined pattern from a standard occupancy signal pattern, the modulated reflected transmit signal may comprise a coded sequence. The coded sequence may take a form similar to a binary waveform, thereby enabling the predetermined pattern to convey bit-like information to the controller of the occupancy sensor.

Alternatively, or in addition, to the coded sequence, an artificial Doppler shift may be introduced to the modulated reflected transmit signal. In this case, the controller may further comprise a moving target indicator to better separate the modulated reflected transmit signal form stationary background signals.

FIGS. 2A and 2B show a schematic of a generic lighting system 40 comprising the occupancy sensor 10 shown in FIG. 1.

FIG. 2A shows the occupancy sensor 10 in communication with a light source 50 and a user 52 within the region of interest of the occupancy sensor. The light source may comprise an LED or any other suitable light emitting device. The transceiver of the occupancy sensor emits transmit signals 60 in the microwave frequency range over the region of interest.

The transmit signals are reflected by the user and various other surfaces within the region of interest in a first signal pattern 64, which travels back towards the occupancy sensor. A portion of the transmit signals will be reflected away from the occupancy sensor; however, by continuously transmitting a large number signals, a sufficient amount of the signals will be reflected towards the occupancy sensor to perform occupancy detection.

In response to receiving the first signal pattern at the transceiver, the controller of the occupancy sensor may detect that the region of interest is occupied. This determination may, for example, lead to the light source being activated.

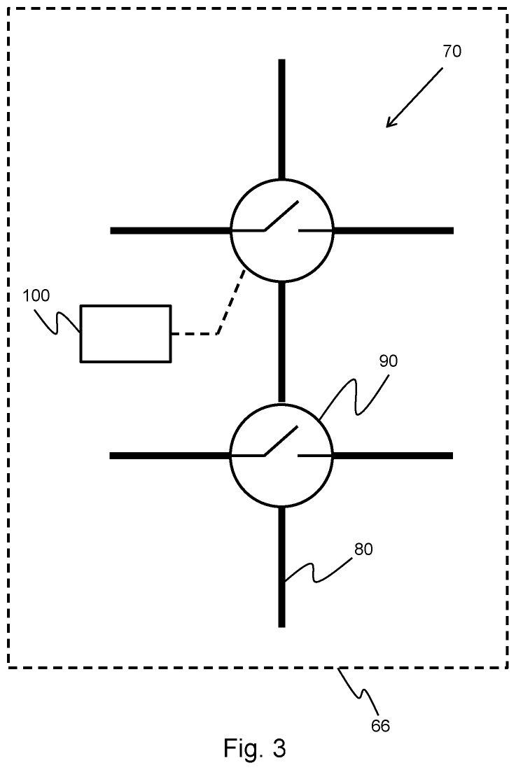

FIG. 2B shows a similar system to FIG. 2A, wherein the occupancy sensor 10 is in communication with a light source 50 and a user 52 within the region of interest; however, in this case, the user possesses an instruction device 66, which is described in more detail in relation to FIG. 3.

As in FIG. 2A, the transceiver of the occupancy sensor transmits signals over the region of interest. The signals are reflected by the user and the instruction device, thereby generating a reflected transmit signal from the user as in the case of standard occupancy, and also a modulated reflected transmit signal having the predetermined pattern 68.

Upon receiving the predetermined pattern at the transceiver, the controller of the occupancy sensor is adapted to interpret the predetermined pattern as a system message. For example, the system message may be an instruction to alter the output of the light source, such as changing the minimum dimming level. Alternatively, the instruction may alter: the colour, including hue, temperature and saturation, of the light; lighting patterns; lighting intensity according to natural light levels; or any other output of the light source. In another example, the message may contain update information for updating the controller software, in which case the predetermined pattern may be accompanied by bit-like information generated by the instruction device.

FIG. 3 shows a schematic view of the instruction device 66 shown in FIG. 2B.

The instruction device includes an antenna structure 70, which is adapted to produce the modulated reflected transmit signal portion of the predetermined pattern. The antenna structure may be entirely passive, meaning that it only re-radiates received transmit signals, or may be partially active, meaning that it is also capable of generating signals independently. In order to efficiently re-radiate the modulated reflected transmit signal directly back towards the transceiver of the occupancy sensor; the antenna structure may comprise a reflect-array. The reflect-array can be either one or two dimensional and connects the antenna elements in pairs located equidistantly from the central plane of symmetry of the reflect-array.

Reflect-array antennas maintain their performance across considerably wider angles of signal incidence compared to the individual elements forming the array. In this way, the user attempting to communicate with the lighting system by way of the instruction device 66 is no longer required to precisely position the instruction device relative to the occupancy sensor in order for the modulated reflected transmit signal to be detected.

The radiating elements of the antenna structure may comprise a dipole wire 80, the length of which may be a quarter of the wavelength of a signal transmitted by the transceiver. In the case that the transmit signals of the transceiver are in the microwave frequency range, the length of the dipole wire may range from 0.25 mm to 0.25 m. For example, for a transmit signal of 3 GHz frequency, the length of the dipole wire would be about 2.5 cm. In this case, the antenna structure may be constructed with a compact design, allowing the instruction device to be operated in a handheld manner. By arranging these quarter-wave dipoles in pairs within the reflect array, half-wave dipoles are formed.

As an alternative to simple dipoles, the radiating elements of the antenna structure may comprise: patch antennas; or slots cut into the walls of a rectangular waveguide.

The instruction device further comprises a switch 90 in communication with the antenna structure, wherein the switch is adapted to change the impedance of the radiating elements of the antenna structure. By altering the impedance of the antenna structure, the waveform of the modulated reflected transmit signal is changed, thereby transmitting an instruction code to the lighting system. The switch may be, for example, a simple mechanical switch or a semiconductor circuit.

For example, the instruction device 66 is carried by a user who moves into the field of view of the transceiver of the occupancy sensor, which may be within a lighting fixture. The occupancy sensor will detect the user, but additionally, once the antenna structure impedance is altered, the received signals at transceiver will also contain the modulated reflected transmit signal. This can then be recognized as the predetermined pattern and interpreted by the controller. By changing the antenna impedance over time the transceiver receive a bit-like pattern. Based on the interpretation of the pattern the controller can execute a predetermined instruction, for example altering the output of a light source.

The antenna structure further comprises a control unit 100, in communication with the switch 90. This control unit may control the switch in order to alter the impedance of the antenna structure in complex patterns, which may be difficult for the user to replicate. For example, if the controller of the occupancy sensor is adapted to recognize a modulated reflected transmit signal with specific time variations, the control unit may be programmed to replicate these time variations based on a simple input of the user, such as a button press. In addition, the control unit may add complex factors to the modulated reflected transmit signal as a further step of differentiating the modulated reflected transmit signal form background signals.

For example, the control unit may implement a coded sequence, such as a maximal length pseudo random binary sequence, adapted to modify the modulated reflected transmit signal. Different coded sequences may be used by the control unit to generate different modulated reflected transmit signals, which may be received by the transceiver of the occupancy sensor and interpreted by the controller to execute different instructions.

In a further example, an artificial Doppler frequency or combination of Doppler frequencies may be emulated by the antenna structure 70. For example, several small bursts of a given frequency may be generated which could never be replicated by the real movement of an object, such as finite changes in speed and direction without an acceleration period. The controller 30 may be adapted to recognize a predetermined pattern of Doppler frequencies as a system message, rather than ordinary movement.

By way of example, normal motion and occupancy detection may be performed as follows. The Doppler shift in the frequency of a moving source, such as an object reflecting the transmit signals, is calculated using the equation below:

$${f}_{Doppler} = \frac{{f}_{0} * v}{c} ,$$

where: f_{Doppler} is the observed Doppler frequency; c is the propagation speed of an electromagnetic wave (˜3*10⁸ m/s for air); v is the velocity of the moving object relative to the medium; and f₀ is the emitted frequency.

For a 5.8 GHz microwave transceiver, the following calculation can then be made. Assuming the object of interest is moving at a speed of 10 km/h (≈2.77 m/s):

$${f}_{Doppler} = \frac{5.8 GHz * 2.77 m \text{/} s}{3 * {10}^{8}} = 54 Hz$$

This 54 Hz Doppler frequency can then be detected by the controller 30 and recognised as motion within the region of interest. Alternatively, the antenna structure 70 may generate Doppler frequencies outside of a range of speeds of interest or with certain predetermined patterns. For example, the antenna structure may emulate subsequent speeds of 10 km/h and 1 km/h alternating every two seconds, a combination that is very unlikely to occur under normal circumstances. The repetition could generate a bit pattern to transfer simple data, as described above.

The signal modulation can further be encoded or provided with a rotating key. In this way the code sequence is continuously altered, providing encrypted binary information originating from the control unit of the instruction device that may then be decrypted at the controller of the occupancy sensor.

In other embodiments, the antenna structure may further comprise: an absorptive switch; a reflective switch; a phase shifter; and/or a vector modulator element. By placing electrically controlled absorptive/reflective switches, phase shifters or vector modulator elements in the interconnections of the antenna structure, the modulated reflected transmit signals can be amplitude, phase or phase and amplitude modulated, respectively. Suitable absorptive/reflective switch elements may be formed from: PIN diodes; field-effect or bipolar transistors; microelectromechanical system (MEMS) devices; or relays. There are many ways in which low loss digital, or continuously adjustable, phase-shifters could be implemented at microwave frequencies For example, high-pass/low-pass filter based designs, reflective phase-shifters or switched-line devices may be used. Similarly, there are multiple ways in which vector modulators can be implemented at microwave frequencies, including the use of microwave hybrids, such as 3 dB power dividers, in combination with adjustable attenuators. These additional elements introduce additional distinguishing features to the modulated reflected transmit signal, thereby further distinguishing the predetermined pattern from background noise.

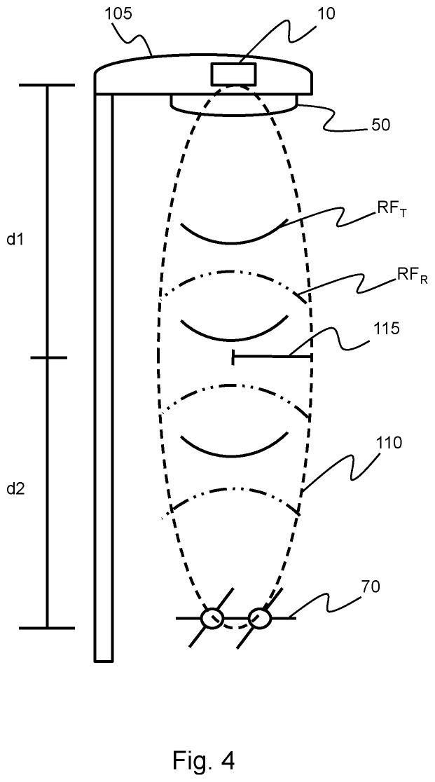

FIG. 4 shows an example of lighting system comprising the occupancy sensor 10 of FIG. 1 and the instruction device 66 of FIG. 3.

A lighting fixture 105 is depicted with an occupancy sensor that includes a transceiver. The transceiver transmits RF microwave signals over a region of interest, shown as wave RF_{T}. This transmit signal is reflected by the instruction device 70, which comprises an antenna structure as described with reference to FIG. 3. The minimum size of the antenna structure is related to the wavelength of the transmit signal. A first Fresnel zone 110 is formed between the antenna structure and the transceiver. The reflected wave RF_{R}, reflected by the antenna structure is reflected in many directions, but the part of the wave is reflected towards the transceiver. In order to ensure that the signal to noise ratio of the reflected signal is as high as possible when received by the transceiver, the antenna structure may be designed to be at least two times the Fresnel zone size, for example three times as large. The radius of the first Fresnel zone is calculated as:

$$r = \sqrt{\frac{λ {d}_{1} {d}_{2}}{{d}_{1} + {d}_{2}}} ,$$

where: r is the radius of the first Fresnel zone between the transceiver and antenna structure; A is the wavelength of the transmit signals; d₁ is the distance between the transceiver and the radius being measured; and d₂ is the distance between the antenna structure and the radius being measured.

By way of example, a typical streetlight, as shown in FIG. 4, may be between 8 and 10 m tall. Taking the total distance between the occupancy sensor 10 and the antenna structure 70 as 8 m for a user located directly beneath the sensor and a transceiver operating at 5.8 GHz as above, the radius 115 at the centre of the first Fresnel zone is given as:

$$r = \sqrt{\frac{λ {d}_{1} {d}_{2}}{{d}_{1} + {d}_{2}}} ∼ \sqrt{\frac{0.05 \times 4 \times 4}{4 + 4}} ∼ 0.32 m$$

This would result in an antenna structure of around 60 cm in length if the largest radius of the first Fresnel zone is used, which may be easily transported and handled by the user.

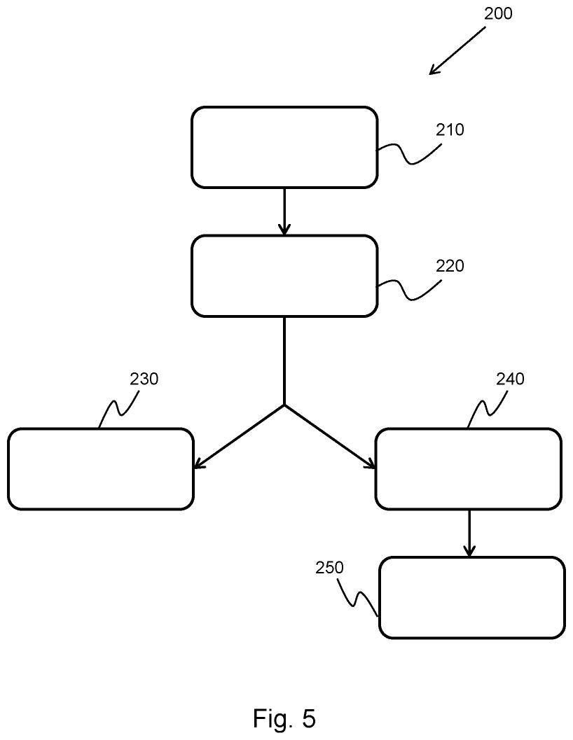

FIG. 5 shows a method 200 for operating an occupancy sensor.

In step 210, signals are transmitted and received by way of a transceiver within the occupancy sensor.

In step 220, the signals received by the transceiver are processed by a controller in communication with the transceiver. The signal patterns may be recognised by the controller as a first or a second received signal pattern.

In step 230, presence may be detected in an area of interest based in the signals received at the transceiver.

Alternatively, in step 240, a predetermined pattern may be detected by the controller, in which case the method may progress to step 250 wherein a system message is interpreted based on the predetermined pattern.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An occupancy sensor, for use in a lighting system, wherein the occupancy sensor comprises:
a transceiver, wherein the transceiver is adapted to transmit signals and to receive reflected signals corresponding to the transmitted signals;
a controller which is adapted to process reflected signals received by the transceiver, and to detect a presence in an area of interest based on the reflected signals received by the transceiver;
wherein the controller is further adapted to detect a predetermined pattern in the reflected signals received by the transceiver; and to interpret a system message based on the predetermined pattern detected in the reflected signals,
wherein the system message contains update information for updating the controller software of the controller.

2. An occupancy sensor as claimed in claim 1, wherein the transceiver is adapted to transmit and receive signals in the microwave frequency range.

3. An occupancy sensor as claimed in claim 1, wherein the transceiver is configured to receive modulated reflected signals.

4. An occupancy sensor as claimed in claim 3, wherein the modulated reflected signals comprises a coded sequence or an artificial Doppler shift.

5. An occupancy sensor as claimed in claim 1, wherein the system message comprises a lighting system control instruction.

6. A lighting system control device for communicating with an occupancy sensor as claimed in claim 1 for providing the predetermined pattern for controlling a light source associated with the occupancy sensor, wherein the control device comprises:
an antenna structure, wherein the antenna structure is adapted to produce the predetermined pattern upon reflecting the transmitted signals; and
a control unit in communication with the antenna structure.

7. A control device as claimed in claim 6, wherein the antenna structure comprises a reflect-array.

8. A control device system as claimed in claim 6, wherein the antenna structure comprises a dipole wire and optionally wherein the length of the dipole wire is a quarter of the wavelength of a signal transmitted by the transceiver of the occupancy sensor.

9. (canceled)

10. A control device as claimed in claim 6, further comprising a switch in communication with the antenna structure and the controller, wherein the switch is adapted to change the impedance of the antenna structure.

11. A control device as claimed in claim 6, wherein the antenna structure further comprises at least one of: an absorptive switch; a reflective switch; a phase shifter; and a vector modulator element.

12. A lighting system, the lighting system comprising:
a light source;
an occupancy sensor according to in claim 1.

13. A system as claimed in claim 12, wherein the system message is adapted to alter the output of the light source.

14. A method for operating an occupancy sensor, the method comprising:
transmitting signals and receiving reflected signals corresponding to the transmitted signals by way of a transceiver;
processing the reflected signals by the transceiver for detecting a presence in an area of interest based on the reflected signals received by the transceiver;
detecting a predetermined pattern in the reflected signals received by the transceiver; and
interpreting a system message based on the predetermined pattern, wherein the system message contains update information for updating the controller software of the controller.

15. The method of claim 14, wherein the predetermined pattern comprises a modulated reflected signals carrying the system message.
